(19) United States
(12) Patent Application Publication
(10) Pub. No.: US 2012/0191348 A1
(43) Pub. Date: Jul. 26, 2012

(54) ELECTRONIC DEVICE AND METHOD FOR DETECTING STATUS OF IMAGE MEASURING MACHINE

(75) Inventors: CHIH-KUANG CHANG, Tu-Cheng (TW); ZHENG-CAI SHE, Shenzhen City (CN); LI JIANG, Shenzhen City (CN); XIAO-GUANG XUE, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD., Shenzhen City (TW)

(21) Appl. No.: 13/221,926

(22) Filed: Aug. 31, 2011

(30) Foreign Application Priority Data
Jan. 20, 2011 (CN) 201110022805.2

(51) Int. Cl. G06F 19/00

(52) U.S. Cl. 702/1

(57) ABSTRACT

A method detects a status of an image measuring machine using an electronic device. The method searches a measuring process of the image measuring machine, records a closed status of the image measuring machine if the measuring process has not been found, obtains status information of the image measuring machine if the measuring process has been found, and calculates a variation of the status information. The method further records a stopped status of the image measuring machine if the variation of the status information is less than a preset value within a specified length of time, or records an operating status of the image measuring machine if the variation of the status information is greater than or equal to the preset value within the specified length of time.

### BACKGROUND

1. Technical Field

Embodiments of the present disclosure relate to measurement technology, and particularly to an electronic device and method for detecting a status of an image measuring machine using the electronic device.

2. Description of Related Art

Measurement is an important phase in manufacturing and is closely related to product quality. In recent years, image measuring machines have been used to obtain a point cloud of an object by scanning a large number of points on a surface of the object, processing the data in the point cloud, and subsequently extracting boundary elements including boundary points and boundary characteristics of the object, in order to form a profile image of the object. However, the current image measuring method cannot automatically monitor a status of the image measuring machine. Therefore, a more efficient method for detecting the status of an image measuring machine is desired.

### BRIEF DESCRIPTION OF THE DRAWINGS

FIG. 1 is a block diagram of one embodiment of an electronic device connected with a plurality of image measuring machines and a server.

FIG. 2 is a block diagram of the electronic device of FIG. 1.

FIG. 3 is a block diagram of a client computer connected with the server of FIG. 1.

FIG. 4 is a flowchart of one embodiment of a method for detecting the status of each of the plurality of image capture devices using the electronic device of the FIG. 1.

FIGS. 5A-5F are exemplary schematic diagrams of the user interfaces of a first setting module of the electronic device.

FIG. 6A is an exemplary schematic diagram of a user interface of a second setting module of the client computer.

FIG. 6B is an exemplary schematic diagram of a user interface for displaying the status of the image measuring machines with a list mode.

FIG. 6C is an exemplary schematic diagram of a user interface for displaying the status of the image measuring machines with a graph mode.

FIG. 6D is an exemplary schematic diagram of a user interface for outputting a measurement report.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

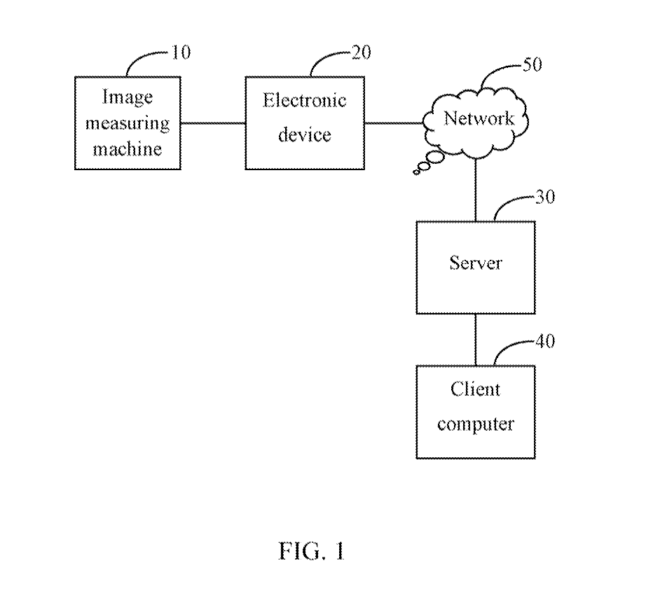

FIG. 1 is a block diagram of one embodiment of an electronic device 20 connected with a plurality of image measuring machines 10 and a server 30. For simplicity, one image measuring machine is illustrated in FIG. 1. In the embodiment, the electronic device 20 connects to the server 30 through a network 50, and the server 30 further connects to a client computer 40. The electronic device 20 may be a data acquisition device, which is used to obtain the status(es) and identification data from the image measuring machine 10, and transmit the obtained data to the server 30 through the network 50. In one embodiment, the network 50 may be an intranet, an ethernet, the Internet or other suitable communication network.

The client computer 40 is used to download information concerning the status(es) and identification data of the image measuring machine 10 at preset intervals (e.g., 10 seconds), and calculate a utilization rate of the image measuring machine 10 according to the downloaded data. A detailed description will be given in the following paragraphs. In one embodiment, the utilization rate of the image measuring machine 10 is defined as how often the image measuring machine 10 is being used per hour or per day. The types of status information regarding the image measuring machine 10 may include a closed status, a stopped status (e.g., a paused status), and an operating status. The identification data of the image measuring machine 10 may include, but is not limited to, a type, a serial number, and an Internet protocol (IP) address of the image measuring machine 10.

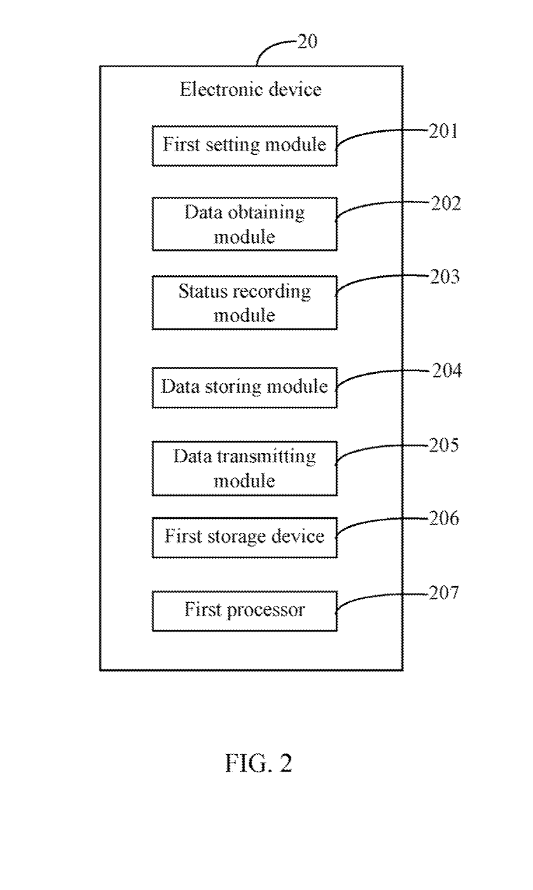

FIG. 2 is a block diagram of the electronic device 20 of FIG. 1. In one embodiment, the electronic device 20 may include one or more modules, for example, a first setting module 201, a data obtaining module 202, a status recording module 203, a data storing module 204, and a data transmitting module 205. The electronic device 20 further includes a first storage device 206 and a first processor 207. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives. The one or more modules 201-205 may comprise computerized code in the form of one or more programs that are stored in the first storage device 206 or memory of the electronic device 20. The computerized code includes instructions that are executed by the first processor 207 to provide functions for the one or more modules 201-205.

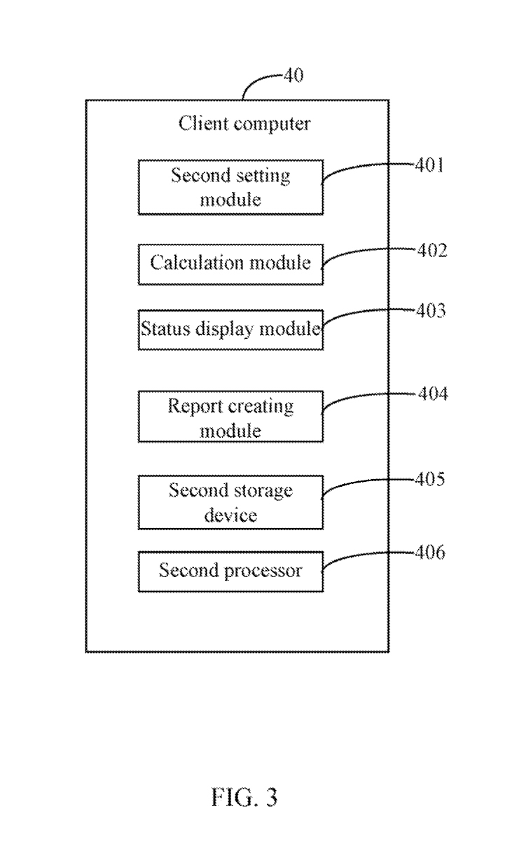

FIG. 3 is a block diagram of the client computer 40 of FIG. 1. In one embodiment, the client computer 40 may include one or more modules, for example, a second setting module 401, a calculation module 402, a status display module 403, and a report creating module 404. The client computer 40 further includes a second storage device 405 and a second processor 406. The one or more modules 401-404 may comprise computerized code in the form of one or more programs that are stored in the second storage device 405 or memory of the client computer 40. The computerized code includes instructions that are executed by the second processor 406 to provide functions for the one or more modules 401-404.

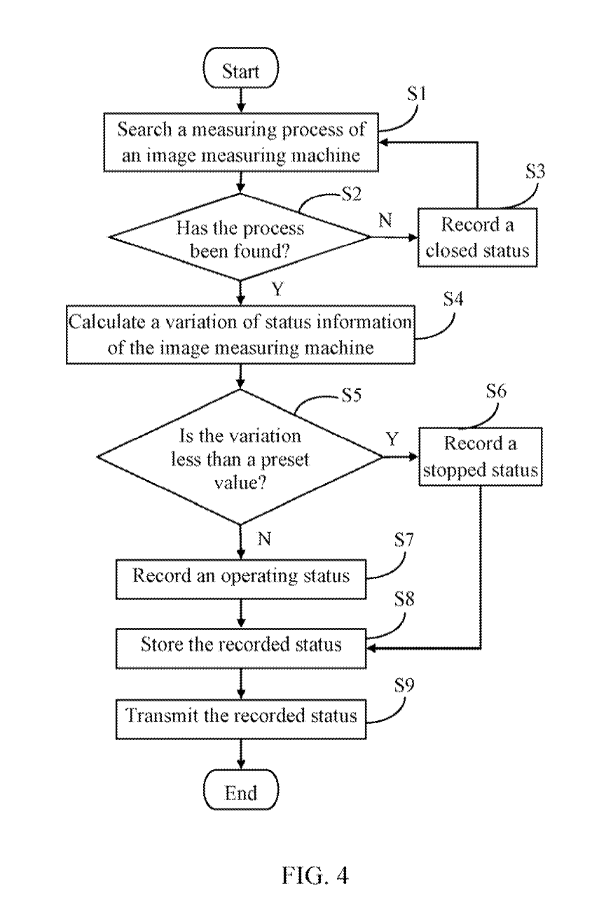

FIG. 4 is a flowchart of one embodiment of a method for detecting the status of the image measuring machine 10 using the electronic device 20. Depending on the embodiment, additional blocks may be added, others removed, and the ordering of the blocks may be changed.

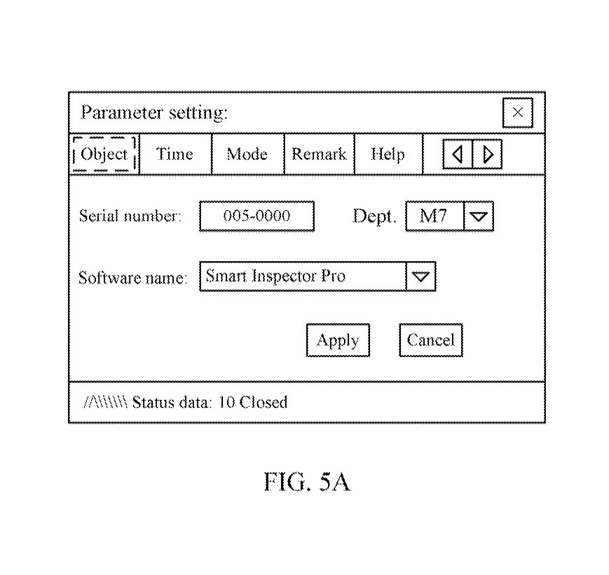

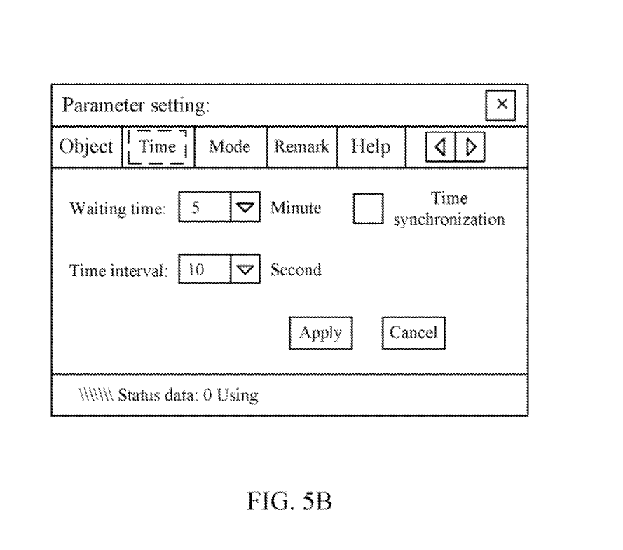

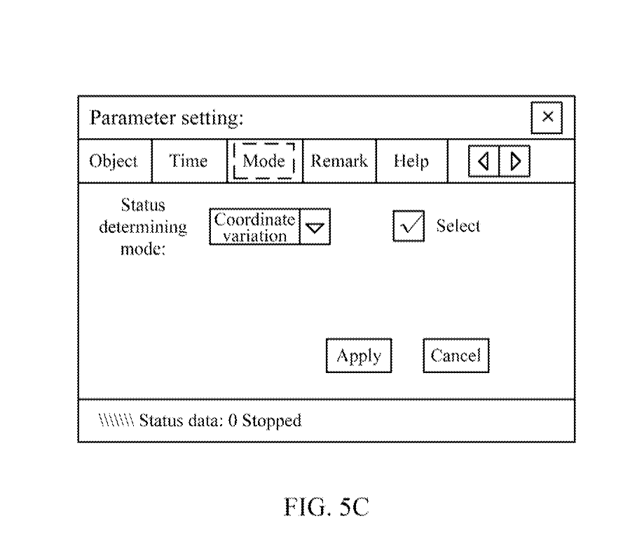

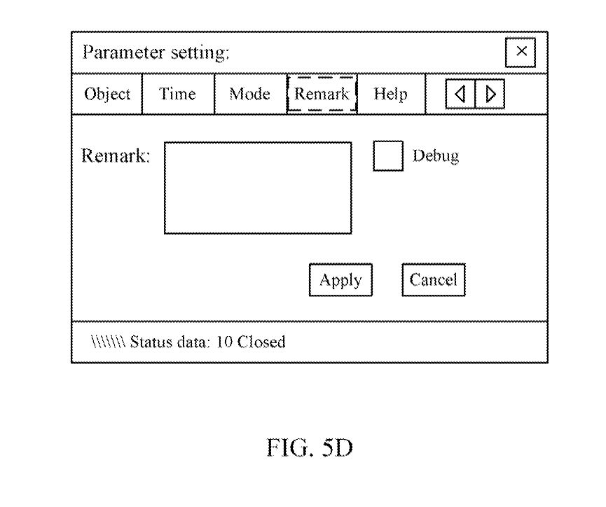

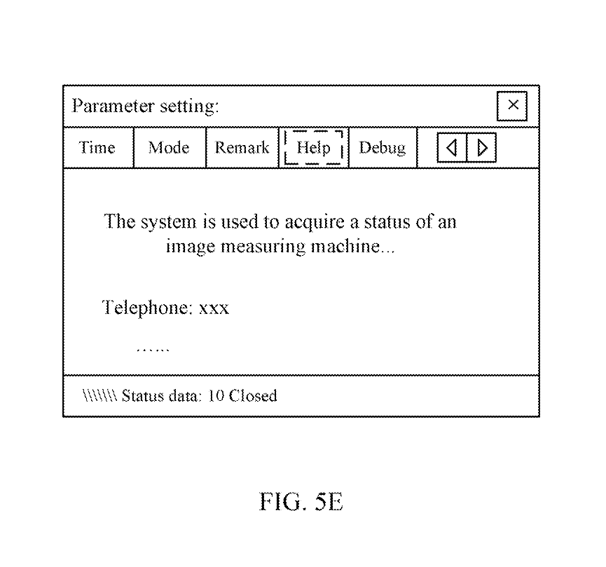

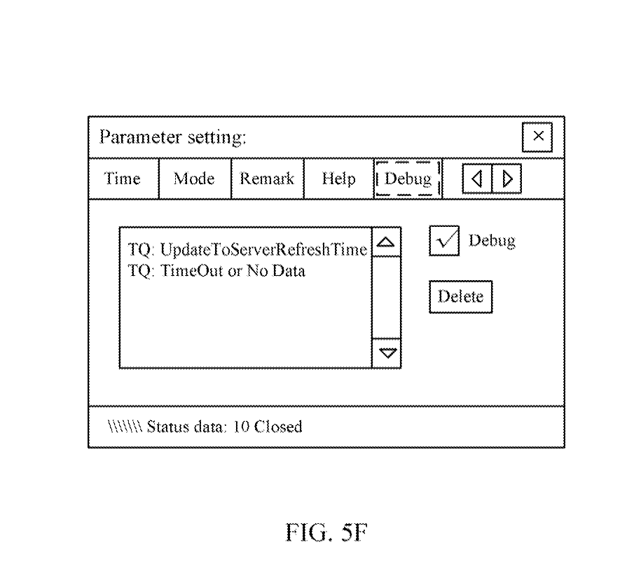

In block S1, the data obtaining module 202 searches a measuring process of the image measuring machine 10 at preset time intervals according to detection parameters from the first storage device 206. In one embodiment, the measuring process is defined as a measurement task which is executed by the electronic device 20 to perform the measurement operation on image measuring machine 10. The detection parameters are preset through the first setting module 201. The detection parameters may include the detection of the serial number of the image measuring machine 10, a name of an image measuring software used in the machine, a waiting time, and a time interval. For example, as shown in FIG. 5A, the name of the image measuring software “Smart Inspector Pro” represents the measuring process of the image measuring machine 10.

In one embodiment, the certain waiting time is used to determine whether the image measuring machine 10 is in the stopped status. That is to say, if no measuring operation is performed by the image measuring machine 10 within a certain period of time (i.e., the waiting time), a determination is made that the image measuring machine 10 is stopped. For example, as shown in FIG. 5B, the waiting period is five minutes. The time interval is used as a parameter in obtaining status information of the image measuring machine 10. In one embodiment, the status information may include obtaining data as to the coordinates of a lens of the image measuring machine 10, or an activity (e.g., a usage rate) of a central processing unit (CPU) in processing data from the measuring process of the image measuring machine 10.

As shown in FIG. 5B, a time synchronization function is provided. In one embodiment, the time synchronization function is used to synchronize time between the electronic device 20 and the server 30. As shown in FIG. 5C, a status determining mode is used to determine whether the image measuring machine 10 is in a operating status. In one embodiment, the status determining mode includes, but is not limited to, a first mode based on movement of the lens of the image measuring machine 10, and/or a second mode based on activity of the CPU occupied by the measuring process of the image measuring machine 10.

In other embodiments, the status determining mode may includes a third mode based on data transmission between the image measuring machine 10 and the electronic device 20, and/or a fourth mode based on the amount of electrical power being consumed by the image measuring machine 10.

An example of a user interface for adding remarks in relation to a particular image measuring machine 10 is shown in FIG. 5D. An example of a user interface for the display characteristics of a particular image measuring machine is shown in FIG. 5E. An example of a user interface for a debugging tool which may be applied to the image measuring machine 10 is shown in FIG. 5F.

In block S2, the data obtaining module 202 determines whether the measuring process of the image measuring machine 10 has been found in block S1. If the measuring process of the image measuring machine 10 has not been found, the procedure goes to block S3. If the measuring process of the image measuring machine 10 has been found, the procedure goes to block S4.

In block S3, the status recording module 203 records information as to the closed status of the image measuring machine 10, and the procedure returns to block S1. The data storing module 204 stores information as to the closed status and corresponding identification data of the particular image measuring machine 10 in the first storage device 206 of the electronic device 20.

In block S4, the status recording module 203 obtains the status information of the image measuring machine 10 according to a preselected status determining mode, and calculates a variation of the status information of the image measuring machine 10.

For example, if the preselected status determining mode is the first mode, the status recording module 203 obtains the coordinates of the lens of the image measuring machine 10, and calculates the variation of the coordinates of the lens of the image measuring machine 10. If the preselected status determining mode is the second mode, the status recording module 203 obtains the activity of the CPU occupied by the measuring process of the image measuring machine 10, and calculates the variation of the activity of the CPU.

In block S5, the status recording module 203 determines whether the variation of the status information of the image measuring machine 10 is less than a preset value within a specified length of time. As mentioned above, the specified length of time is the waiting time in FIG. 5B. If the variation of the status information is less than the preset value within the specified length of time, the procedure goes to block S6. If the variation of the status information is greater than or equal to the preset value within the specified length of time, the procedure goes to block S7.

For example, if the preselected status determining mode applied is the first mode, the status recording module 203 determines whether the variation of the coordinates of the lens of the image measuring machine 10 is less than a first preset value (e.g., 2 millimeters). If the preselected status determining mode is the second mode, the status recording module 203 determines whether the variation of the activity of the CPU occupied by the measuring process of the image measuring machine 10 is less than a second preset value (e.g., 1%).

In block S6, the status recording module 203 records information as to the stopped status of the image measuring machine 10, and the procedure goes to block S8.

In block S7, the status recording module 203 records information as to the operating status of the image measuring machine 10, and records an operating time of the image measuring machine 10.

In block S8, the data storing module 204 stores the information as to the status (i.e., the stopped status or the operating status) and the identification data of the image measuring machine 10 in the first storage device 206 of the electronic device 20.

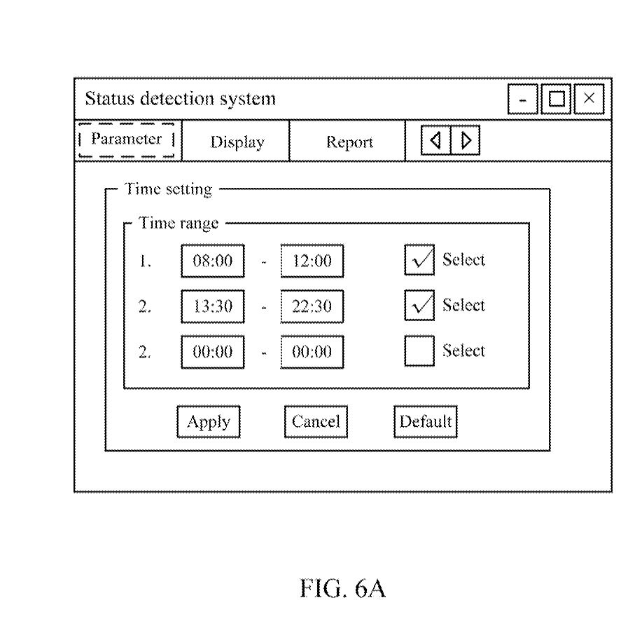

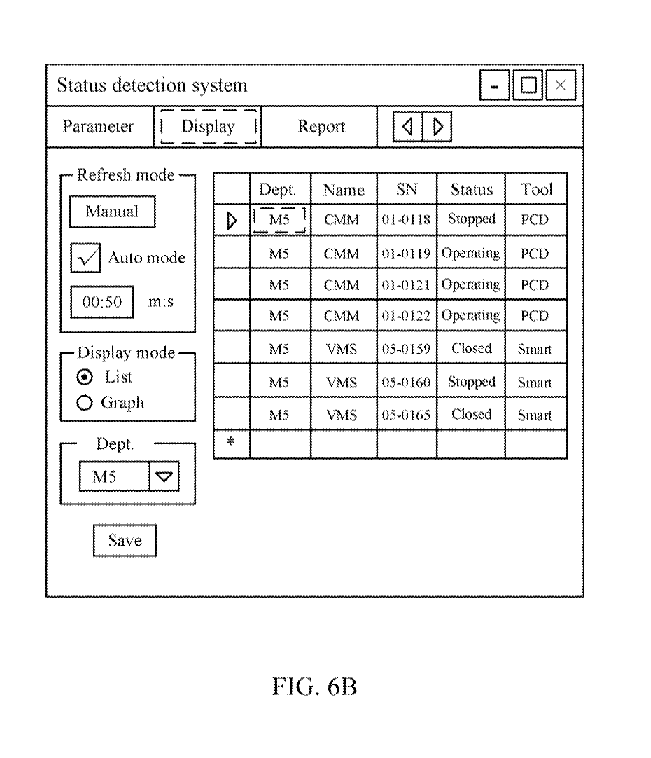

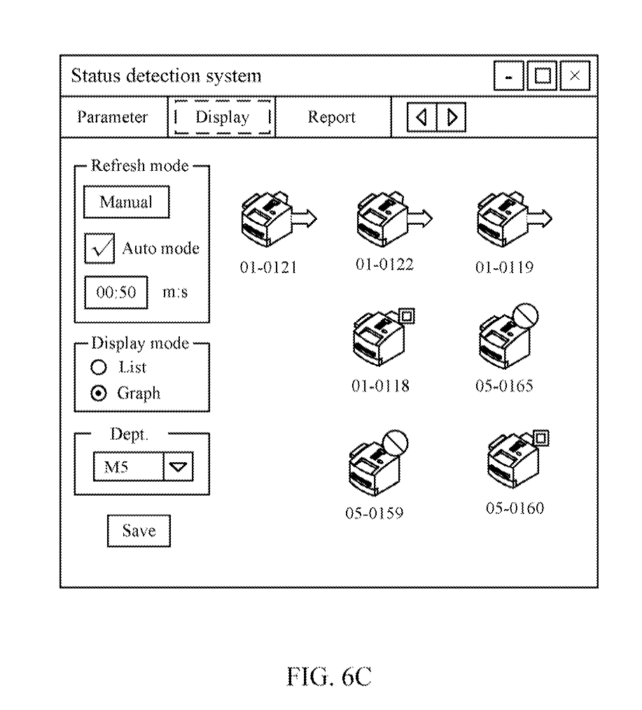

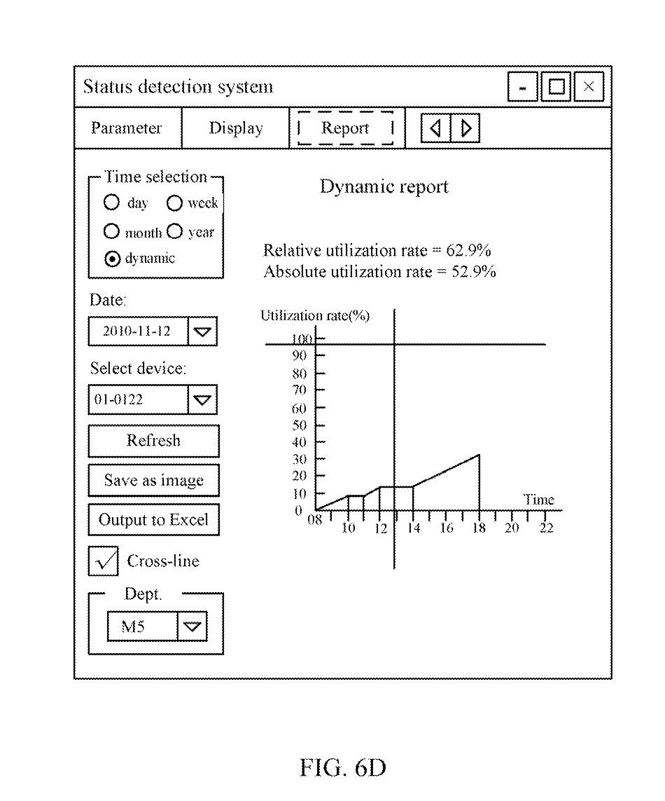

In block S9, the data transmitting module 205 transmits information as to the status and the identification data of the image measuring machine 10 to the server 30. Then, the client computer 40 downloads the information as to the status and the identification data of the image measuring machine 10 according to a preset download time from the server 30. An example of a user interface for setting the download time using the second setting module 401 is shown in FIG. 6A.

The calculation module 402 calculates the utilization rate of the image measuring machine 10 according to the total amount of the operating time of image measuring machine 10. In one embodiment, the utilization rate of the image measuring machine 10 may include a relative utilization rate and an absolute utilization rate. For example, suppose that “u1” represents the relative utilization rate, “u2” represents the absolute utilization rate, “t0” represents the operating time of the image measuring machine 10, “t1” represents total hours of use of the image measuring machine 10, and “t2” represents the total working hours in one day. Thus, u1=t0/t1, and u2=t0/t2.

The status display module 403 displays the information which has been recorded as to the status and the identification data of the image measuring machine 10 on a display screen of the client computer 40, according to a preselected display mode. In one embodiment, the display mode may be a list mode for displaying the information as to the recorded status and the identification data with a list format (see FIG. 6B), or it may be a graph mode for displaying the information as to the recorded status and the identification data with a graph format (see FIG. 6C). As shown in FIG. 6C, an icon of an image measuring machine displaying “01-0121” represents the operating status, an icon of an image measuring machine displaying “01-0118” represents the stopped status, and an icon of an image measuring machine displaying “05-0165” represents the closed status.

The report creating module 404 generates a status report of the image measuring machine 10, and displays the utilization rate of the image measuring machine 10 in the status report (see FIG. 6D).

In other embodiments, the server 30 and the client computer 40 may be removed, the electronic device 20 may execute all the functions described above. That is to say, the one or more modules 401-404 may be stored in the first storage device 206 of the electronic device 20 and executed by the first processor 207 to provide functions for the one or more modules 401-404.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A method for detecting a status of an image measuring machine using an electronic device, the method comprising:
searching a measuring process of the image measuring machine from a storage device of the electronic device at preset time intervals;
recording information as to a closed status of the image measuring machine upon the condition that the measuring process of the image measuring machine has not been found;
obtaining status information of the image measuring machine according to a preselected status determining mode upon the condition that the measuring process of the image measuring machine has been found, and calculating a variation of the status information of the image measuring machine;
recording information as to a stopped status of the image measuring machine upon the condition that the variation of the status information is less than a preset value within a specified length of time;
recording information as to an operating status of the image measuring machine upon the condition that the variation of the status information is greater than or equal to the preset value within the specified length of time, and recording an operating time of the image measuring machine; and
storing the information as to the recorded status and the identification data of the image measuring machine in the storage device.

2. The method according to claim 1, wherein the status determining mode is a first mode based on movement of a lens of the image measuring machine, or a second mode based on any activity of a central processing unit (CPU) occupied by the measuring process of the image measuring machine.

3. The method according to claim 2, wherein the variation of the status information of the image measuring machine is calculated by:
obtaining coordinates of the lens of the image measuring machine upon the condition that the preselected status determining mode is the first mode, and calculating the variation of the coordinates of the lens of the image measuring machine; or
obtaining the activity of the CPU occupied by the measuring process of the image measuring machine upon the condition that the preselected status determining mode is the second mode, and calculating the variation of the activity of the CPU occupied by the measuring process of the image measuring machine.

4. The method according to claim 1, further comprising:
displaying the information as to the recorded status and the identification data of the image measuring machine on a display screen of the electronic device according to a preselected display mode.

5. The method according to claim 4, wherein the display mode is a list mode for displaying the information as to the recorded status and the identification data with a list format, or a graph mode for displaying the information as to the recorded status and the identification data with a graph format.

6. The method according to claim 1, further comprising:
calculating a utilization rate of the image measuring machine according to the operating time of image measuring machine; and
generating a status report of the image measuring machine, and displaying the utilization rate of the image measuring machine in the status report.

7. An electronic device, comprising:
a storage device;
at least one processor; and
one or more modules that are stored in the storage device and are executed by the at least one processor, the one or more modules comprising instructions:
to search a measuring process of the image measuring machine from a storage device of the electronic device at preset time intervals;
to record information as to a closed status of the image measuring machine upon the condition that the measuring process of the image measuring machine has not been found;
to obtain status information of the image measuring machine according to a preselected status determining mode upon the condition that the measuring process of the image measuring machine has been found, and calculate a variation of the status information of the image measuring machine;
to record information as to a stopped status of the image measuring machine upon the condition that the variation of the status information is less than a preset value within a specified length of time;
to record information as to an operating status of the image measuring machine upon the condition that the variation of the status information is greater than or equal to the preset value within the specified length of time, and record an operating time of the image measuring machine; and
to store the information as to the recorded status and identification data of the image measuring machine in the storage device.

8. The electronic device according to claim 7, wherein the status determining mode is a first mode base on movement of a lens of the image measuring machine, or a second mode base on any activity of a central processing unit (CPU) occupied by the measuring process of the image measuring machine.

9. The electronic device according to claim 8, wherein the variation of the status information of the image measuring machine is calculated by:
obtaining coordinates of the lens of the image measuring machine upon the condition that the preselected status determining mode is the first mode, and calculating the variation of the coordinates of the lens of the image measuring machine; or
obtaining the activity of the CPU occupied by the measuring process of the image measuring machine upon the condition that the preselected status determining mode is the second mode, and calculating the variation of the activity of the CPU occupied by the measuring process of the image measuring machine.

10. The electronic device according to claim 7, wherein the one or more modules further comprise instructions of: displaying the information as to the recorded status and the identification data of the image measuring machine on a display screen of the electronic device according to a preselected display mode.

11. The electronic device according to claim 10, wherein the display mode is a list mode for displaying the status and the corresponding identification data with a list format, or a graph mode for displaying the status and the corresponding identification data with a graph format.

12. The electronic device according to claim 7, wherein the one or more modules further comprise instructions of:
calculating a utilization rate of the image measuring machine according to the operating time of image measuring machine; and
generating a status report of the image measuring machine, and displaying the utilization rate of the image measuring machine in the status report.

13. A non-transitory storage medium having stored thereon instructions that, when executed by a processor of an electronic device, causes the electronic device to perform a method for detecting a status of an image measuring machine, the method comprising:
searching a measuring process of the image measuring machine from a storage device of the electronic device at preset time intervals;
recording information as to a closed status of the image measuring machine upon the condition that the measuring process of the image measuring machine has not been found;
obtaining status information of the image measuring machine according to a preselected status determining mode upon the condition that the measuring process of the image measuring machine has been found, and calculating a variation of the status information of the image measuring machine;
recording information as to a stopped status of the image measuring machine upon the condition that the variation of the status information is less than a preset value within a specified length of time;
recording information as to an operating status of the image measuring machine upon the condition that the variation of the status information is greater than or equal to the preset value within the specified length of time, and recording an operating time of the image measuring machine; and
storing the information as to the recorded status and identification data of the image measuring machine in the storage device.

14. The non-transitory storage medium according to claim 13, wherein the status determining mode is a first mode based on movement of a lens of the image measuring machine, or a second mode based on any acitivity of a central processing unit (CPU) occupied by the measuring process of the image measuring machine.

15. The non-transitory storage medium according to claim 14, wherein the variation of the status information of the image measuring machine is calculated by:
obtaining coordinates of the lens of the image measuring machine upon the condition that the preselected status determining mode is the first mode, and calculating the variation of the coordinates of the lens of the image measuring machine; or
obtaining the activity of the CPU occupied by the measuring process of the image measuring machine upon the condition that the preselected status determining mode is the second mode, and calculating the variation of the activity of the CPU occupied by the measuring process of the image measuring machine.

16. The non-transitory storage medium according to claim 13, wherein the method further comprises:
displaying the information as to the recorded status and the identification data of the image measuring machine on a display screen of the electronic device according to a preselected display mode.

17. The non-transitory storage medium according to claim 16, wherein the display mode is a list mode for displaying the information as to the recorded status and the identification data with a list format, or a graph mode for displaying the information as to the recorded status and the identification data with a graph format.

18. The non-transitory storage medium according to claim 13, wherein the method further comprises:
calculating a utilization rate of the image measuring machine according to the operating time of image measuring machine; and
generating a status report of the image measuring machine, and displaying the utilization rate of the image measuring machine in the status report.

19. The non-transitory storage medium according to claim 13, wherein the medium is selected from the group consisting of a hard disk drive, a compact disc, a digital video disc, and a tape drive.
